(19) United States
(12) Patent Application Publication
(10) Pub. No.: US 2026/0296219 A1
(43) Pub. Date: Oct. 1, 2026

(54) EXTENDING RANGE OF A ROBOTIC ELECTRIC VEHICLE

(71) Applicant: Textron Systems Corporation, Hunt Valley, MD (US)

(72) Inventors: Zachary J. Smith, Hanover, PA (US); Jason Scott Steinberg, Owings Mills, MD (US)

(21) Appl. No.: 19/629,719

(22) Filed: Mar. 26, 2026

Related U.S. Application Data
(60) Provisional application No. 63/779,568, filed on Mar. 28, 2025.

(51) Int. Cl. B60L 50/62; B60L 50/13; B60L 50/51; B60W 20/40; B62D 55/06; B62D 55/112

(52) U.S. Cl. CPC B60L 50/62; B60L 50/13; B60L 50/51; B60W 20/40; B62D 55/06; B62D 55/1125; B60L 2240/445

(57) ABSTRACT

An electric robotic vehicle has an electric propulsion system constructed and arranged to maneuver the electric robotic vehicle within an environment, and a robotic vehicle body coupled with the electric propulsion system, the robotic vehicle body defining a compartment. The electric robotic vehicle further has a modular electrical power generating apparatus which includes a set of electrical power generating devices constructed and arranged to generate electrical power, a combustion engine constructed and arranged to drive the set of electrical power generating devices, and a modular frame constructed and arranged to support the set of electrical power generating devices and the combustion engine within a modular form factor that enables the modular electrical power generating apparatus to install and operate within the compartment defined by the robotic vehicle body to provide electrical power for electric robotic vehicle propulsion.

### CROSS REFERENCE TO RELATED APPLICATIONS

This application is a regular utility application based on earlier-filed U.S. Application No. 63/779,568 filed on Mar. 28, 2025, entitled "Tactical Range Extender (TREX)", the contents and teachings of which are hereby incorporated by reference in their entirety.

### BACKGROUND

A conventional electric vehicle includes an electric motor and a battery to power the electric motor. The battery supplies electrical power to the electric motor to produce torque which moves the electric vehicle.

A conventional hybrid (parallel or series) vehicle includes an electric motor and a battery, plus an internal combustion engine and a gas tank. If the battery is low on charge, the internal combustion engine runs on gas from the gas tank to provide torque which moves the hybrid vehicle, as well as to recharge the battery. If the torque created by the engine is directed into the drivetrain and into a generator, then the hybrid is known to be Parallel. If the engine torque is directed only into a generator, where electricity is then redistributed for electric drivetrain use, the hybrid is known to be Series.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a side view of an electric robotic vehicle which utilizes a modular electrical power generating apparatus in accordance with certain embodiments.

FIG. 2 is a general layout view of the electric robotic vehicle in accordance with certain embodiments.

FIG. 3 is a block diagram showing various details for the modular electrical power generating apparatus in accordance with certain embodiments.

FIG. 3A is a perspective view showing various details for the modular electrical power generating apparatus in accordance with certain embodiments.

FIG. 4 is a block diagram showing certain details for a portion of the vehicle's electrical system in accordance with certain embodiments.

FIG. 5 is a block diagram showing certain details of the portion of the vehicle's electrical system when the modular electrical power generating apparatus is connected in accordance with certain embodiments.

FIG. 6 is a block diagram showing certain details regarding a fuel management assembly of the modular electrical power generating apparatus in accordance with certain embodiments.

FIG. 7 is a block diagram showing certain details regarding an air handling system of the modular electrical power generating apparatus in accordance with certain embodiments.

FIG. 8 is a flowchart of a procedure which is performed to control an electric robotic vehicle in accordance with certain embodiments.

### DETAILED DESCRIPTION

Unfortunately, when the battery of the conventional electric vehicle is low on charge, the battery must be reconnected to a suitable electrical power source to recharge the battery. Accordingly, the range of the conventional electric vehicle is limited based on proximity to a suitable electrical power source.

On the other hand, when the battery of the conventional hybrid vehicle is low on charge, the internal combustion engine runs on gas from the gas tank to provide torque which moves the hybrid vehicle, as well as to recharge the battery. Although the conventional hybrid vehicle may provide more range than the conventional electric vehicle, the hybrid vehicle requires the complexity of integrating the internal combustion engine into the hybrid vehicle's drivetrain to enable the internal combustion engine to provide the torque which moves the hybrid vehicle. Unfortunately, such integration of the internal combustion engine into the drivetrain creates a burdensome design that makes assembly, repairs, and part replacement more difficult and costly.

As an alternative, one might consider configuring a conventional electric vehicle to tow a conventional electrical power generator on a trailer so that, when the battery is low on charge, the conventional electrical power generator on the trailer can be used to recharge the battery. Unfortunately, such a combination is impractical for certain applications such as in the context of a robotic electric vehicle when there is no one available to hookup the conventional electrical power generator to the electric vehicle, in an all-terrain situation in which the environment is unsuitable for towing the trailer at even moderate speeds, and so on.

What is needed, therefore, is way to enable an electric vehicle to have greater range than a conventional electric vehicle, but without the complexity of integrating an internal combustion engine into the drivetrain as with a conventional parallel hybrid vehicle.

The above need is addressed at least in part by an improved technique which involves utilizing a modular electrical power generating apparatus that is able to install and operate within a compartment of an electric robotic vehicle to provide electrical power. Along these lines, such a modular apparatus may include a combustion engine and a set of generators to supply electrical power which is sufficient to simultaneously drive the electric robotic vehicle within the environment as well as recharge the batteries thus greatly extending the operating range of the vehicle. Such a technique is well-suited for certain applications such as remotely operating a robotic tracked vehicle in a silent mode (e.g., running exclusively on electrical power from the batteries) and a non-silent mode (e.g., running on electrical power from the combustion engine driving the set of generators). Moreover, with such a modular apparatus installed and operating within the compartment of the electric robotic vehicle, electrical power generating equipment is effectively carried on and protected by the vehicle so there is no need to for any towing on a trailer.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

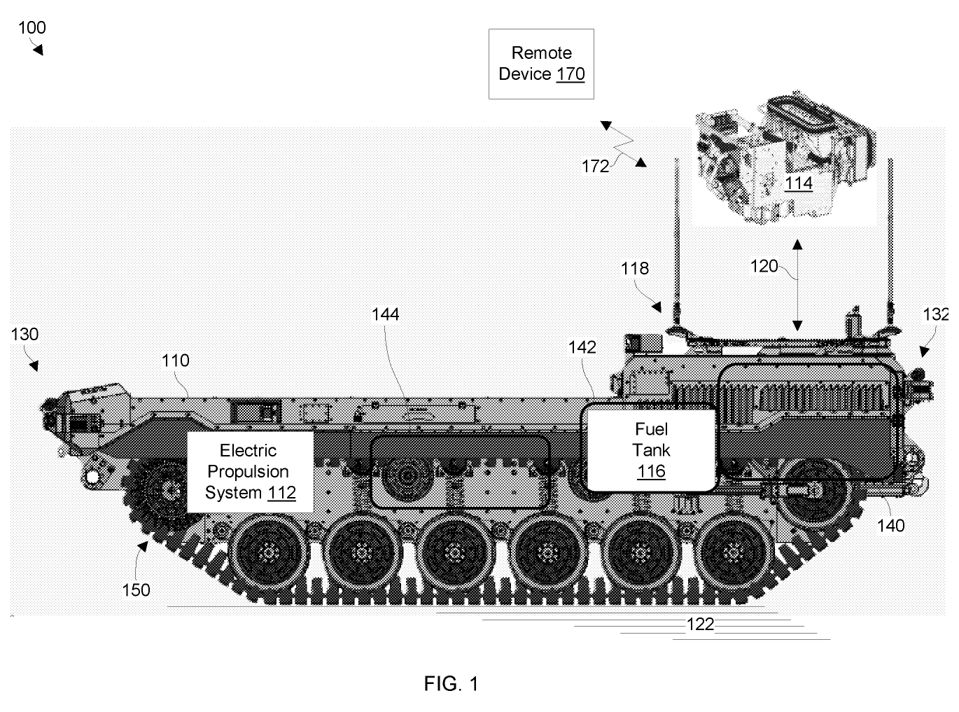

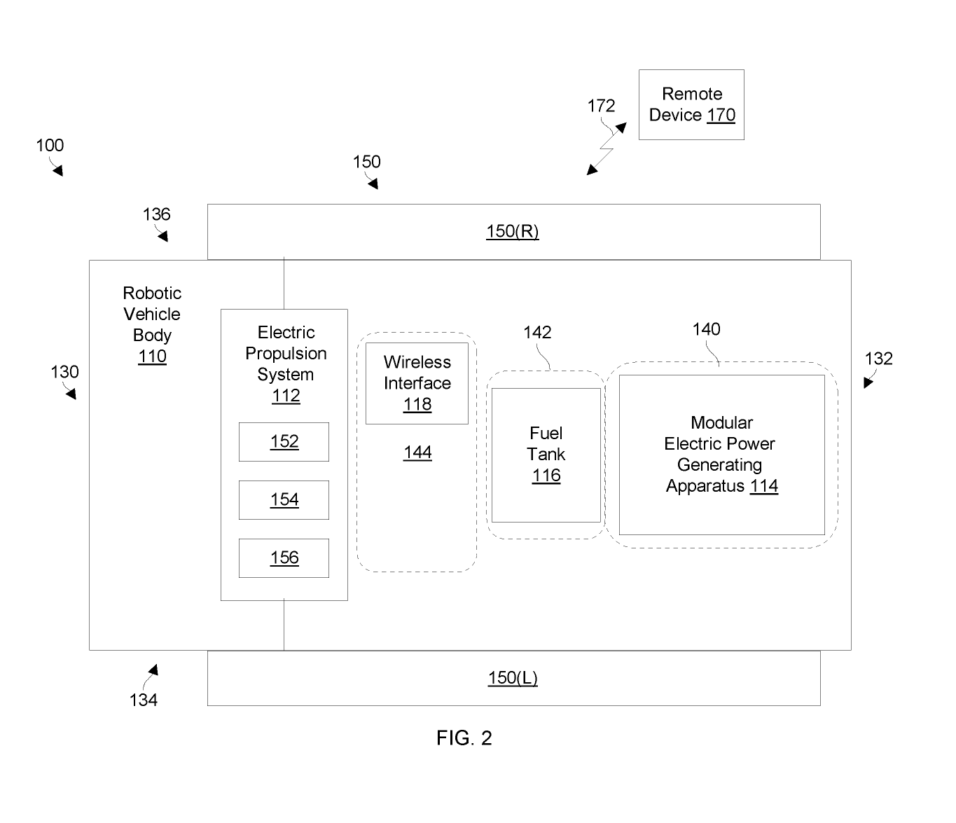

FIGS. 1 and 2 show an electric robotic vehicle 100 which utilizes a modular electrical power generating apparatus in accordance with certain embodiments. FIG. 1 is a side view of the electric robotic vehicle 100. FIG. 2 is a general layout view of the electric robotic vehicle 100 showing certain components.

The electric robotic vehicle 100 includes a robotic vehicle body 110, an electric propulsion system 112, a modular electrical power generating apparatus 114, a fuel tank 116, and a wireless interface and controller 118. The double arrow 120 in FIG. 1 illustrates the ability of the modular electrical power generating apparatus 114 to be installed within and removed from the robotic vehicle body 110. The electric robotic vehicle 100 may include other componentry as well such as sensors, lighting, specialized control circuitry, specialized payload equipment, and so on (which may have been omitted from FIGS. 1 and 2 for simplicity).

The robotic vehicle body 110 is constructed and arranged to provide a structure for carrying equipment and enabling the vehicle 100 to operate within various environments 122. Along these lines, the robotic vehicle body 110 defines a front 130, a back 132, a left side 134 and a right side 136 (also see FIG. 2). The robotic vehicle body 110 further defines a compartment (or bay) 140 to hold the modular electrical power generating apparatus 114, a fuel tank space 142 to hold the fuel tank 116, and one or more other areas 144 to hold other equipment, etc. In some arrangements, one or more of these internal areas are combined together, integrated, or shared.

In accordance with certain embodiments, the modular electrical power generating apparatus 114 is designed as a replaceable unit. Along these lines, it should be appreciated that various tie-ins (e.g., vehicle connectors, ports, channels, etc.) for the modular electrical power generating apparatus 114 may be provided within the compartment 140 or immediately adjacent the compartment 140. Such tie-in positioning facilitates installation/removal/access for the modular electrical power generating apparatus 114.

The particular material, geometry, and design of the robotic vehicle body 110 are suitable for traversing and/or handling various terrains which may be smooth, rough, hilly, uneven, irregular, etc. (e.g., roads, fields, sand, hills, ditches, rocky areas, uneven slopes, outcrops, creeks, marshes, wetlands, combinations thereof, and so on). Moreover, the other areas 144 are shown generally within the robotic vehicle body 110, but it should be appreciated that such other areas 144 may be positioned within, partitioned and/or distributed throughout the robotic vehicle body 110 for optimized equipment placement regarding connectivity, weight distribution, equipment accessibility for servicing, protection against the elements, heat management, and so on.

The electric propulsion system 112 is constructed and arranged to maneuver the electric robotic vehicle 100 within the various environments 122. Along these lines, the electric propulsion system 112 includes a set of ground engaging members 150, a set of electric traction motors 152, a set of batteries 154, and propulsion control circuitry 156 (also see FIG. 2).

The set of ground engaging members 150 is constructed and arranged to engage with terrain to move the vehicle 100. By way of example and as shown in FIG. 1, the set of ground engaging members 150 may include tracks (or track loops) 150(L), 150(R) to enable the electric robotic vehicle 100 to traverse both even and uneven surfaces. Nevertheless, it should be understood that other types of ground engaging members are suitable for use in addition to or as an alternative to the tracks (e.g., wheels, skis, legs, etc.).

The set of electric traction motors 152 couple with the robotic vehicle body 110 and with the set of ground engaging members 150. The set of electric traction motors 152 is constructed and arranged to operate the ground engaging members 150 to move the electric robotic vehicle 100 through the environment 122. In some arrangements, the set of electric traction motors 152 includes a left side set of electric motors (or motor portions) to operate a left track on the left side of the robotic vehicle body 110, and a right side set of electric motors (or motor portions) to operate a right track on right side of the robotic vehicle body 110.

The set of batteries 154 resides within the robotic vehicle body 110, and is constructed and arranged to store electrical power which may then be used to operate the set of electric traction motors 152 to maneuver the electric robotic vehicle 100 within the environment 122, as well as supply power to other electrical equipment.

The propulsion control circuitry 156 resides within the robotic vehicle body 110, and couples with the set of electric traction motors 152 and the set of batteries 154. The propulsion control circuitry 156 is constructed and arranged to control delivery of electrical power from the set of batteries 154 to the set of electric traction motors 152 to enable the electric robotic vehicle 100 to maneuver within the environments 122. Along these lines, the propulsion control circuitry 156 includes a controller, inverters, etc.

The modular electrical power generating apparatus 114 has a form factor enabling the modular electrical power generating apparatus 114 to fit within the compartment 140 defined by the robotic vehicle body 110. The modular electrical power generating apparatus 114 is constructed and arranged to install and operate within the compartment 140 to provide electrical power for electric robotic vehicle propulsion (e.g., to operate the electric propulsion system 112), to charge the set of batteries 154, and/or to supply power to other equipment.

The fuel tank 116 resides within the fuel tank space 142 defined by the robotic vehicle body 110. The fuel tank 116 is constructed and arranged to hold liquid fuel for use by the modular electrical power generating apparatus 114. In some arrangements, the fuel tank 116 is able to hold 40-50 gallons of heavy fuel.

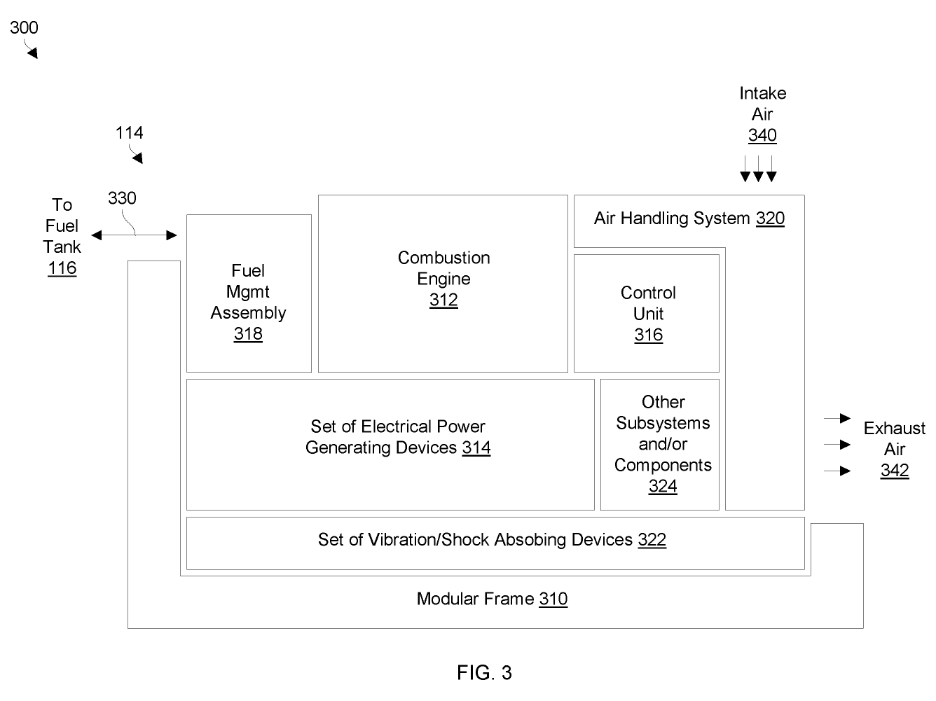

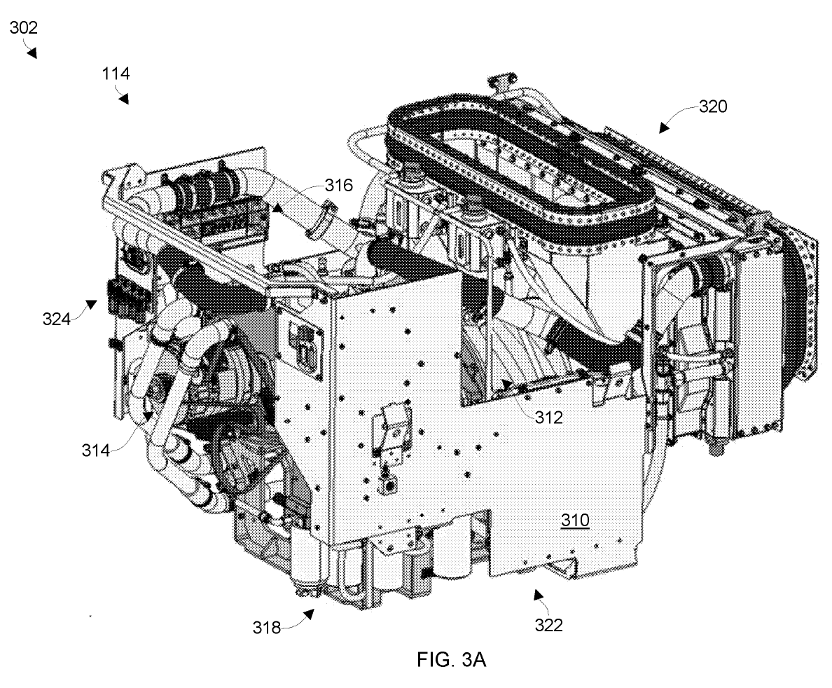

The wireless interface and controller 118 couples with other circuitry of the vehicle 100 (e.g., the propulsion control circuitry 156) and is constructed and arranged to communicate with a remote device 170 (e.g., a base station, a remote controller, etc.). Along these lines, the wireless interface 118 may send wireless signals 172 to and receive wireless signals 172 from the remote device 170 to exchange information such as status, commands, data, and so on for various vehicle and non-vehicle operations. The wireless interface and controller 118 may then impose control over various systems of the vehicle 100 or communicate with such systems to enable the systems to impose control. Further details will now be provided with reference to FIGS. 3 and 3A.

FIGS. 3 and 3A show various details for the modular electrical power generating apparatus 114 in accordance with certain embodiments. FIG. 3 is a general view 300 of the modular electrical power generating apparatus 114 in accordance with certain embodiments. FIG. 3A is a perspective view 302 of the modular electrical power generating apparatus 114 in accordance with certain embodiments. Along these lines, the modular electrical power generating apparatus 114 (or simply the modular apparatus 114) includes a modular frame 310, a combustion engine 312, a set of electrical power generating devices 314, a control unit 316, a fuel management assembly 318, an air handling system 320, a set of vibration/shock absorbing devices 322, and other subsystems and/or components 324.

The modular frame (or cradle) 310 is constructed and arranged to provide robust and reliable support for the other componentry of the modular apparatus 114. Additionally, the modular frame 310 enables such componentry to remain together in an efficient and effective form factor so that the modular apparatus 114 easily installs and fastens within the compartment 140 defined by the robotic vehicle body 110 (also see FIGS. 1 and 2). Furthermore, the modular frame 310 enables such componentry to remain together compactly if the modular apparatus 114 is de-installed, temporarily removed for servicing, replaced with a similar modular apparatus 114, etc.

Along these lines, the modular frame 310 may support and carry the weight of the other componentry while the modular apparatus 114 is placed into the compartment 140 (e.g., lowered, slid into, etc.) during installation and/or removal (e.g., raised, slid out of, etc.). Furthermore, while the modular frame 310 resides within the compartment 114, the modular frame 310 firmly attaches to the robotic vehicle body 110 in a manner that prevents the other componentry from sustaining damage (e.g., contacting, interfering with, coming apart from, etc. other components of the vehicle 100). In some arrangements, a portion of the modular frame 310 includes mechanical structures/features (e.g., rails, hangers, lips, tabs, guides, standoffs, recesses, protrusions, combinations thereof, etc.) which engage or interface with corresponding mechanical structures/features of the robotic vehicle body 110 to retain the modular apparatus 114 in place even while the vehicle 100 is in motion and/or performing other operations.

The combustion engine 312 is constructed and arranged to operate the set of electrical power generating devices 314 so that electrical power is generated for the vehicle 100. Along these lines and as will be explained in further detail shortly, the combustion engine 312 couples with various other componentry which facilitate control and operation (e.g., fluid lines, air ducts, electrical cables, etc.).

In some arrangements, the combustion engine 312 runs on heavy fuel from the vehicle's fuel tank 116 (e.g., an eco-diesel engine). However, nothing precludes the combustion engine 312 from running on fuel from a different source and/or running on other types of fuel (e.g., JET-A, JP-8, JET-A1, etc.).

It should be appreciated that the combustion engine 312 may be put through different phases during operation. Along these lines, on startup, the combustion engine 312 may be idled at a first speed (e.g., 700-1000 rpm) for a warmup period while the combustion engine 312 reaches an optimal operating temperature. Next, the combustion engine 312 may be run at a second speed (e.g., 2000 rpm) and service a power demand of up to a predefined maximum (e.g., 80-100 kW). The combustion engine 312 may be further put through a normal shutdown where the engine 312 is commanded to idle at a lower speed and cool down before stopping, or an emergency shutdown where all loads are removed and the engine 312 is immediately commanded off. In some arrangements, there is no other maintenance such as priming or bleeding fluid that must be performed either prior to or after vehicle run.

In some arrangements, the combustion engine 312 in a series hybrid vehicle may be smaller and operate with better fuel efficiency compared to a larger engine that would be required to connect with and power a drive train in a parallel hybrid vehicle. This advantage in fuel efficiency makes this solution more ecologically friendly.

The set of electrical power generating devices 314 is constructed and arranged to generate electrical power for the vehicle 100 in response to torque from the combustion engine 312. Along these lines and as will be explained in further detail shortly, the set of electrical power generating devices 314 may provide enough electrical power to drive the set electric traction motors 152 and charge the set of batteries 154 of the electric propulsion system 112 simultaneously.

The control unit 316 is constructed and arranged to control operation of the modular apparatus 114. Along these lines, the control unit 316 may take input (e.g., from the wireless interface and controller 118, from the propulsion control circuitry 156, from user controls, from a vehicle control unit executing a mission plan, combinations thereof, etc.) to selectively run in silent mode (e.g., where the combustion engine 312 is off) or non-silent mode (e.g., where the combustion engine 312 is on). For example, the control unit 316 may run the combustion engine 312 in response to a run command from the remote device 170 and/or disable the combustion engine 312 in response to a disable command from the remote device 170 (also see FIGS. 1 and 2). As another example, the control unit 316 may control and/or sense other operating aspects of the modular apparatus 114 (e.g., engine speed, electrical power delivery, fans, pumps, etc.).

The fuel management assembly 318 is constructed and arranged to manage fuel from the vehicle's fuel tank 116 for use by the combustion engine 312. Along these lines and as will be explained in further detail shortly, the fuel management assembly 318 may include an intake path (or intake fuel line) which delivers fuel from the vehicle's fuel tank 116 to the combustion engine 312 and a return path (or return fuel line) which returns unused fuel from the combustion engine 312 back to the vehicle's fuel tank 116. Such access to the fuel tank 116 is illustrated by the double arrow 330 in FIG. 3.

The air handling system 320 is constructed and arranged to handle air flow for modular apparatus 114 (e.g., to support operation of the combustion engine 312). During operation, intake air 340 may be drawn from a first location (e.g., above the modularized apparatus 114 and exhaust air 342 may be output to a second location (e.g., out to an external location adjacent the back 132 of the vehicle 100, also see FIGS. 1 and 2). Such operation may provide engine cooling, cooling of air for combustion, exhaust direction control, and so on. In some arrangements, there is a turbocharger and an intercooler to enhance combustion engine performance.

The set of vibration/shock absorbing devices 322 is constructed and arranged to protect the modular apparatus 114 against vibration, shock, and other movement that may be detrimental. Along these lines, the set of vibration absorbing devices 322 includes pneumatic/hydraulic shock absorbing devices to dampen (or soften) movement among the various components of the modular apparatus 114 and/or movement of such components relative to the vehicle 100. Additional vibration absorbing devices may be present as well such as coils, springs, cushioning/dampening members (e.g., elastomeric spacers, standoffs, pads, etc.), and so on.

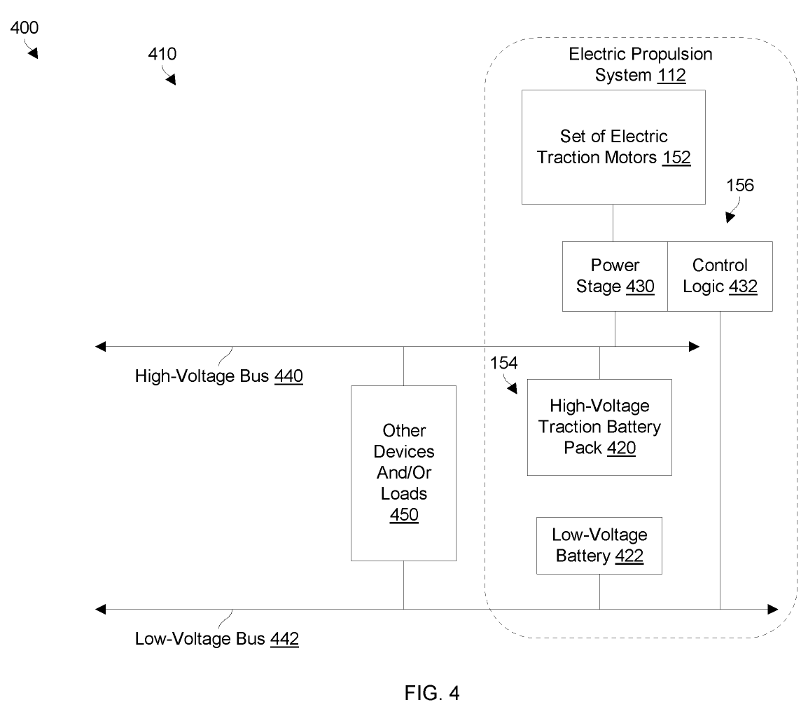

The other subsystems and/or components 324 refer to other componentry of the modular apparatus 114 to support, facilitate, and/or optimize utility of the modular apparatus 114. Such componentry may include hardware which enables installation, removal, attachment, etc. (e.g., hooks, cables, levers, detents, and the like). Such componentry may further include covers, access panels, heatsinks, ties, couplers, connectors, sensors, other electronics, user controls, and so on. Further details will now be provided with reference to FIGS. 4 through 7.

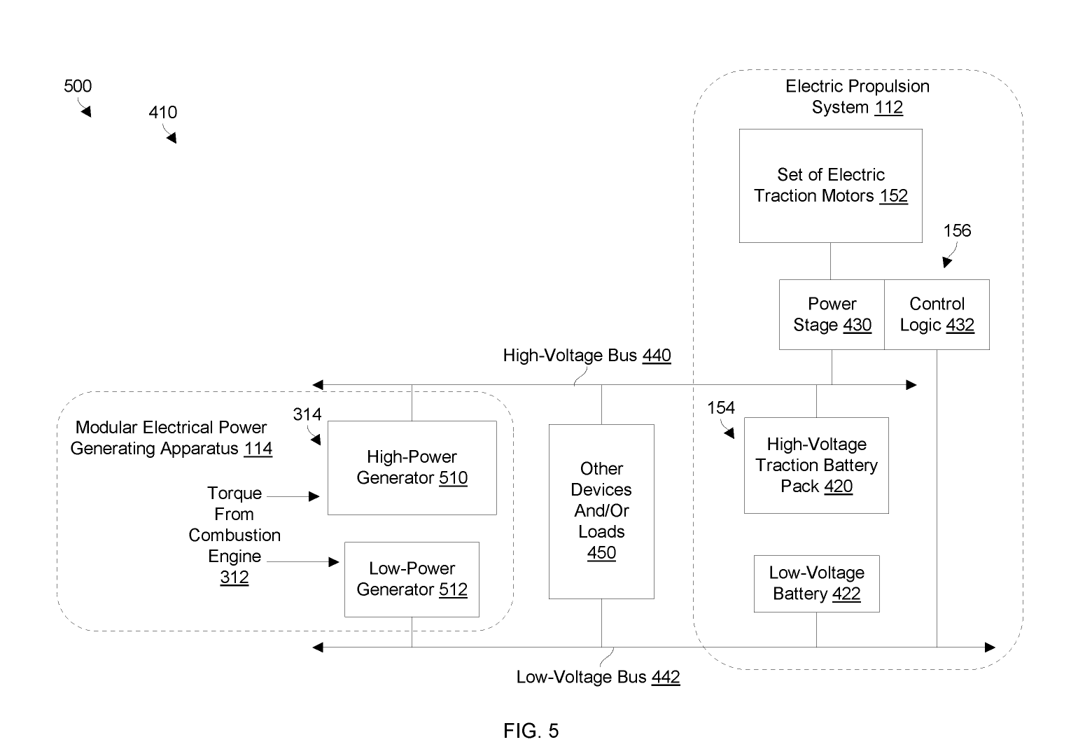

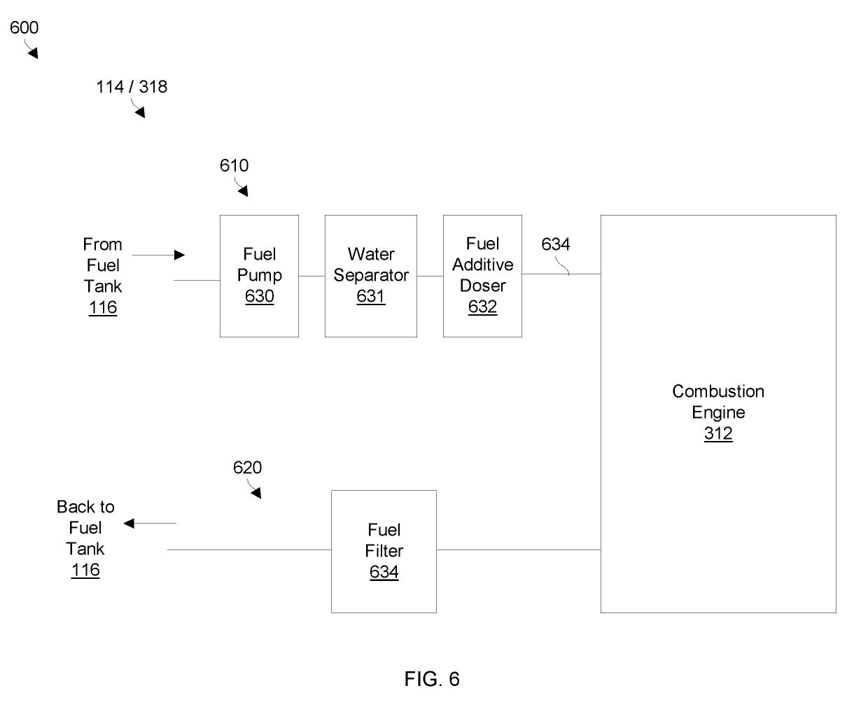

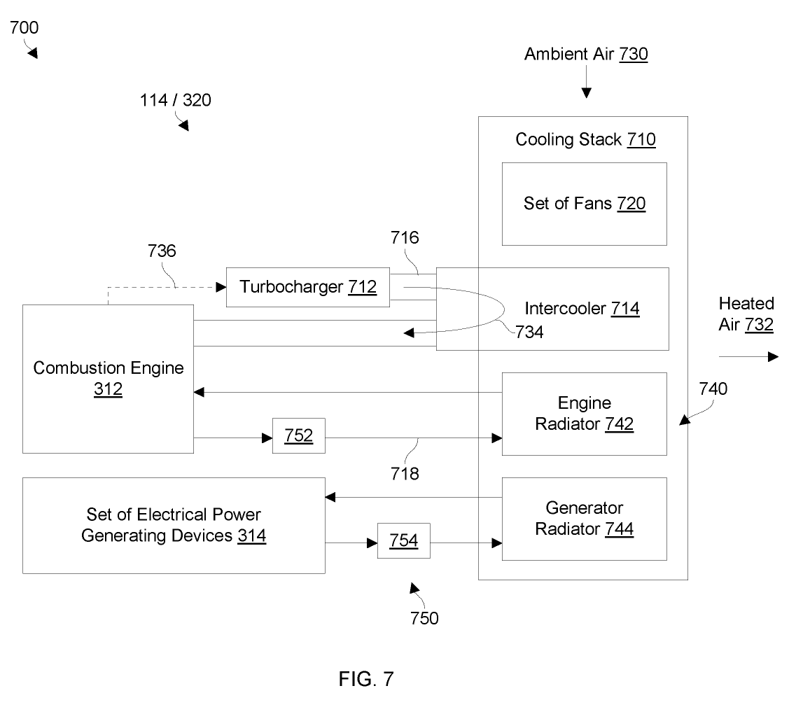

FIGS. 4 through 7 show certain details for various aspects of the electric robotic vehicle 100 in accordance with certain embodiments. FIG. 4 shows certain details for a portion of the vehicle's electrical system 410. FIG. 5 shows certain details when the modular apparatus 114 is connected with the vehicle's electrical system 410. FIG. 6 shows certain details regarding the fuel management assembly 318 of the modular apparatus 114. FIG. 7 shows certain details regarding the air handling system 320 of the modular apparatus 114.

FIG. 4 shows a view 400 of various details for a portion of the vehicle's electrical system 410 in accordance with certain embodiments. As shown, the electric propulsion system 112 forms part of the overall electrical system 410 (also see FIG. 2). Along these lines, the set of batteries 154 of the electric propulsion system 112 includes a high-voltage traction battery pack 420 and a low-power battery 422. Additionally, the propulsion control circuitry 156 of the electric propulsion system 112 includes a power stage 430 and control logic 432.

The power stage 430 couples with the set of electric traction motors 152 and further with the high-voltage traction battery pack 420 through a high voltage bus 440. Additionally, the control logic 432 couples with the power stage 430 and further with the low-power battery 422 through a low voltage bus 442.

It should be understood that certain low-level electrical features and details such as ground connections, rectifiers to produce direct current power, fuses, switches, relays, contactors, battery management circuits, software-controlled power distribution units, etc. may have been omitted to simplify the drawings. However, such electrical features and details do exist on the vehicle 100 (e.g., see the other devices and/or loads 450). Moreover, such componentry is nicely packaged into a shock and vibration isolated, modular unit, allowing for easy maintenance and adaptable functionality.

The high-voltage traction battery pack 420 is constructed and arranged to supply electrical power to the set of electric traction motors 152 through the high voltage bus 440 and the power stage 430. Furthermore, the low-power battery 422 is constructed and arranged to supply electrical power to the control logic 432 as well as other loads of the vehicle's electrical system 410 (e.g., the wireless interface and controller 118, sensors, lights, etc.) through the low voltage bus 442.

It should be appreciated that the vehicle's electrical system 410 may further include other electrical equipment (e.g., represented by the other devices and/or loads 450 in FIG. 4). Along these lines, such other electrical equipment may include inverters, other power signal conditioning hardware, safety components, communications and control devices, specialized payload equipment, user input/output (I/O) circuitry, and so on.

During operation, the control logic 432 controls how the power stage 430 delivers electrical power to the set of electric traction motors 152. Such control enables how the vehicle 100 maneuvers within the environment 122 (also see FIGS. 1 and 2).

For example, to control the left track 150(L) on the left side 134 of the robotic vehicle body 110, there may be a set of left-side motor components (e.g., motor sections, modules, segments, etc.). Likewise, to control the right track 150(R on the right side 136 of the robotic vehicle body 110, there may be a set of right-side motor components. These components of the set of electric traction motors 152 control steering, direction, rotation, etc. of the vehicle 100 within the environment 122 by moving the tracks 150(L), 150(R) of the vehicle 100 in particular directions and at particular speeds (also see FIG. 2). It should be understood that such operation does not require the presence of the modular apparatus 114 as shown in FIG. 4.

Alternatively or in addition to the tracks 150(L), 150(R), the set of electric traction motors 152 may perform similar operations on other types of ground engaging members (e.g., tires, legs, etc.) to maneuver the vehicle 100 within the environment 122. Again, it should be understood that such operation does not require the presence of the modular apparatus 114 as shown in FIG. 4.

FIG. 5 shows a view 500 of various details of the vehicle's electrical system 410 when the modular apparatus 114 is fully installed within the compartment 140 of the robotic vehicle body 110 in accordance with certain embodiments. As shown in FIG. 5, the vehicle's electrical system 410 includes the electrical components of the electric propulsion system 112 as earlier explained in connection with FIG. 4. However, with the modular apparatus 114 is now electrically connected with, and thus part of, the vehicle's electrical system 410.

Along these lines, the set of electrical power generating devices 314 of the modular apparatus 114 includes a high-voltage generator 510 and a low-voltage generator 512. The high-voltage generator 510 couples with the high voltage bus 440. In some arrangements, the high-voltage generator 510 is constructed and arranged to provide 600 to 800 VDC.

The low-voltage generator 512 couples with the low voltage bus 442. In some arrangements, the low-voltage generator 512 is constructed and arranged to provide 28 VDC.

During operation and as mentioned earlier, the modular apparatus 114 may run in silent mode (e.g., with the combustion engine 112 off) or in non-silent mode (e.g., with the combustion engine 112 on and running the set of electrical power generating devices 314). In some arrangements, when the modular apparatus 114 is in silent mode, the control unit 316 remains at the ready to transition to the non-silent mode and run the combustion engine 112 (e.g., in response to a local or remote command). Similarly, in some arrangements, when the modular apparatus 114 is in non-silent mode, the control unit 316 remains at the ready to transition to the silent mode and stop the combustion engine 112 from running.

When the modular apparatus 114 is in non-silent mode, the high-voltage generator 510 supplies electrical power on the high voltage bus 440. Along these lines, the high-voltage generator 510 may take the form of a brushless permanent magnet motor. In some arrangements, the electrical power provided by the high-voltage generator 510 is sufficient to drive the set of electric traction motors 152 and charge the high-voltage traction battery pack 420 at the same time. In some arrangements, the high-voltage generator 510 is constructed and arranged to provide at least 75 kW (e.g., 80 kW, 100 kW, etc.) continuously (e.g., suitable for operating a robotic electric tank). In some arrangements, the high-voltage generator 510 includes a high-voltage, three-phase alternating current (AC) alternator constructed and arranged to produce three-phase AC power.

Additionally, when the modular apparatus 114 is in non-silent mode, the low-voltage generator 512 supplies electrical power on the low voltage bus 442. Along these lines, the low-voltage generator 512 is constructed and arranged to continuously produce a lower voltage than that of the high-voltage generator 510. In some arrangements, the electrical power provided by the low-voltage generator 512 is sufficient to power the control logic and other lower-voltage loads of the vehicle 100, as well as charge the low-voltage battery 422 at the same time.

FIG. 6 shows a view 600 of various details regarding the fuel management assembly 318 of the modular apparatus 114 in accordance with certain embodiments (also see FIG. 3). As shown in FIG. 6, the electric propulsion system 112 includes a fuel intake path 610 and a fuel return path 620.

The fuel intake path 610 is constructed and arranged to deliver fuel from the vehicle's fuel tank 116 to the combustion engine 312 of the modular apparatus 114. The fuel intake path 610 includes a fuel filter and water separator 628, low pressure a fuel pump 630, a fuel additive doser 632, and lines 634 (e.g., hoses, tubing, piping, etc.). During operation, the fuel filter and water separator 628 filters the fuel and removes water to protect the engine 312 in the event there is contamination. Additionally, the fuel pump 630 supplies the fuel. Furthermore, the fuel additive doser 632 lubricates the fuel and/or improves fuel solubility by introducing a lubricity additive to the fuel en route to the combustion engine 312 (e.g., by providing a correct level of additive to enable the combustion engine 312 to handle fuels such as JET-A, JP-8, JET-A1, etc.). The fuel intake path 610 may include other componentry as well (e.g., one or more filters, one or more degassers, etc.).

The fuel return path 620 is constructed and arranged to return unused fuel from the combustion engine 312 back to the vehicle's fuel tank 116. Along with additional lines 634, the fuel return path 620 includes a fuel filter 640 to remove particulates to localize damage in the event of a failure. The additional filtration allows for polishing of the fuel, even while just being stored in the fuel tank, as well as monitoring of both the High Pressure and Low Pressure Fuel Pump health. It should be appreciated that the fuel filter 640 may be provided in multiple devices (e.g., multiple filters, a standalone device to remove water, etc.). Moreover, the various components of the fuel intake path 610 and/or the fuel return path 620 may be disposed in a different order and/or provided as integrated devices or multiple devices which are interleaved with each other for enhanced fuel conditioning.

It should be appreciated that, in accordance with certain embodiments, the fuel tank 116 from which the fuel is drawn and to which the fuel is returned resides in the vehicle 100 and not on the modular apparatus 114. Such an arrangement enables a reduction in the form factor and complexity of the modular apparatus 114 by placing the details for supporting, securing, and managing the fuel tank 116 on the vehicle 100 instead.

In accordance with other embodiments, the modular apparatus 114 includes a fuel tank. Such a feature enables the modular apparatus 114 to operate as a standalone unit.

FIG. 7 shows a view 700 of various details regarding the air handling system 320 of the modular apparatus 114 in accordance with certain embodiments (also see FIG. 3). As shown in FIG. 7, the air handling system 320 includes a cooling stack 710, a turbocharger 712, an intercooler 714, ducting 716, fluid lines 718, and a set of fans 720.

The cooling stack 710 is constructed and arranged to intake ambient air 730 from a location above the robotic vehicle body 110 and exhaust heated air 732 to a location adjacent a back side of the robotic vehicle body 110 in response to operation of the set of fans 720 (also see FIGS. 1 and 2). Along these lines, the cooling stack 710 may be disposed along the back 132 of the robotic vehicle body 110 between the left side 134 and the right side 136 as shown in FIG. 2. Such location and operation enables the vehicle 100 to isolate (or restrict) a large portion of the vehicle's heat signature to the back 132. In addition to including structures to support components such as the intercooler 714 and the set of fans 720 and as will be explained in more detail shortly, the cooling stack 710 further includes a set of radiators 740 to facilitate heat release from fluids (e.g., oil, coolant, etc.) that are fed through the cooling stack 710.

The turbocharger 712 is constructed and arranged to provide compressed air 734 to the intercooler 714 for intake by the combustion engine 312. The turbocharger 712 achieves such air compression in response to exhaust 736 from the combustion engine 312. Along these lines, the turbocharge 712 may use a turbine which is driven by the engine exhaust 736 to drive a compressor that provides the compressed air 734.

The intercooler 714 is constructed and arranged to cool the compressed air 734 before the compressed air 734 enters the combustion engine 312. Along these lines, at least a portion of the intercooler 714 resides within the cooling stack 710.

The ducting 716 is constructed and arranged to channel air flow among the various other components of the air handling system 320, the combustion engine 312, and external locations around the vehicle 100. It should be appreciated that such ducting 716 may be relatively compact and efficient due to placement and/or assembly of the modular apparatus 114 outside of the vehicle 100 prior to installation of the modular apparatus 114 within the vehicle 100.

The fluid lines 718 are constructed and arranged to carry fluids between the combustion engine 312 and the set of electrical power generating devices 314, and the set of radiators 740 of the cooling stack 710. In particular, the set of radiators 740 includes an engine radiator 742 to release heat from fluid (e.g., oil) from the combustion engine 312, and a generator radiator 744 to release heat from fluid (e.g., coolant) from the set of electrical power generating devices 314.

It should be appreciated that a set of cooling pumps 750 resides along the lines 718 to facilitate fluid circulation with the set of radiators 740 in order to maintain temperatures. For example, a first fluid pump 752 (e.g., a coolant pump) circulates fluid to cool the combustion engine 312 (although the combustion engine 312 may be provisioned with an oil cooler, the first fluid pump 752 circulates coolant between the engine block and the engine radiator 742 for further heat removal). As another example, a second fluid pump 754 (e.g., a coolant pump) circulates fluid to cool the high-voltage generator 510 of the set of electrical power generating devices 314 (also see FIG. 5).

The set of fans 720 is constructed and arranged to provide air flow through one or more chambers within the cooling stack 710. Along these lines, the set of fans 720 may intake the ambient air 730 from the environment 122 (e.g., above the robotic vehicle body 110), move the air across/through the intercooler 714 and the set of radiators 740, and exhaust heated air 732 out the back 132 of the robotic vehicle body 110.

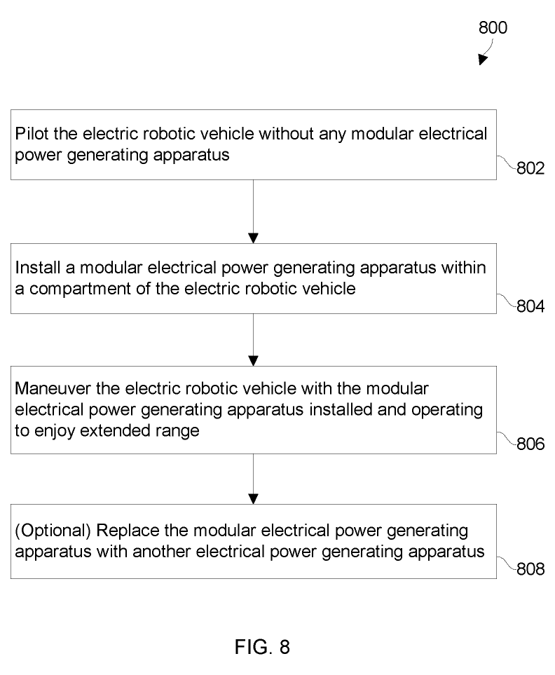

In some arrangements, the air handling system 320 is equipped with noise canceling and/or dampening components. Along these lines, the air handling system 320 includes a mufflered exhaust system in some arrangements (e.g., where the turbocharger 712 outputs exhaust air out a separate path to the mufflered exhaust system). Such componentry may muffle the engine exhaust, reduce or eliminate fan noise, and so on. Further details will now be provided with reference to FIG. 8.

FIG. 8 shows a procedure 800 to control an electric robotic vehicle. A suitable electric robotic vehicle is disclosed earlier in connection with FIGS. 1 and 2.

The procedure 800 may be performed at least in part by equipment (e.g., automated apparatus). However, the procedure 800 may also be performed by a user (or operator), e.g., via a remote controller.

At 802, the equipment (or user) may pilot the electric robotic vehicle within an environment without any modular electrical power generating apparatus. Along these lines, the electric robotic vehicle has (i) an electric propulsion system which is constructed and arranged to maneuver the electric robotic vehicle within the environment, and (ii) a robotic vehicle body coupled with the electric propulsion system (e.g., also see FIGS. 1 and 2).

At 804, the equipment (or user) installs a modular electrical power generating apparatus within a compartment defined by the robotic vehicle body. Along these lines, the modular electrical power generating apparatus includes a set of electrical power generating devices constructed and arranged to generate electrical power, a combustion engine constructed and arranged to drive the set of electrical power generating devices, and a modular frame constructed and arranged to support the set of electrical power generating devices and the combustion engine within a modular form factor. Such a form factor enables the modular electrical power generating apparatus to install and operate within the compartment defined by the robotic vehicle body to provide electrical power for electric robotic vehicle propulsion.

At 806, the equipment (or user) maneuvers the electric robotic vehicle within the environment while the modular electrical power generating apparatus is installed and operates within the compartment. Accordingly, the operating range of the electric robotic vehicle is extended beyond that which is available without the modular electrical power generating apparatus. In the context of a tracked vehicle, the vehicle is able to effectively and efficiently navigate over various terrains that would be difficult or impossible for a non-tracked vehicle to traverse.

At 808 (optionally), after the modular electrical power generating apparatus is installed within the compartment defined by the robotic vehicle body, the equipment (or user) replaces the modular electrical power generating apparatus with another modular electrical power generating apparatus to enable the electric robotic vehicle to maneuver within the environment while the other modular electrical power generating apparatus is installed and operates within the compartment. This feature makes certain vehicle repairs and/or servicing easier and more practical compared to a situation in which equipment is not modularized in the manners disclosed herein.

It should be understood that nothing precludes the electric robotic vehicle 100 from being provided with the modular electrical power generating apparatus 114 already installed (e.g., tested and shipped from the manufacturer in assembled form). Even in such cases (e.g., skipping 802), the modular electrical power generating apparatus 114 may be removed and/or replaced (e.g., for servicing, for repair, etc.).

As described above, improved techniques involve utilizing a modular electrical power generating apparatus 114 that is able to install and operate within a compartment 140 of an electric robotic vehicle 100 to provide electrical power thus extending the operating range of the vehicle 100. Along these lines, such a modular apparatus 114 may include a combustion engine 312 and a set of electrical power generating devices 314 to supply electrical power which is sufficient to simultaneously drive the vehicle 100 within the environment 122 as well as recharge the vehicle's batteries 154 thus greatly extending the operating range of the vehicle 100. Such a technique is well-suited for certain applications such as remotely operating a robotic tracked vehicle in a silent mode (e.g., running exclusively on electrical power from the batteries) and a non-silent mode (e.g., running on electrical power from the combustion engine driving the set of generators). Moreover, with such a modular apparatus 114 installed and operating within the compartment 140 of the vehicle 100, electrical power generating equipment is effectively carried on and protected by the vehicle 100 so there is no need to for any towing on a trailer.

It should be appreciated that some of the improvements disclosed herein relate generally to the field of electric vehicles. Although the modular electrical power generating apparatus 114 was described above as installing and operating within a land or ground based vehicle, it should be understood that the modular electrical power generating apparatus 114 is suitable for use by other types of craft as well such as aircraft, watercraft, etc. (e.g., the set of ground engaging members 150 may be replaced with a set of propellers and the set of electric traction motors 152 may be repurposed to turn the set of propellers, etc.).

In a particular use case, the robotic electric vehicle takes the form of a tank suitable for offroad applications. Along these lines, the various componentry (including the modular electrical power generating apparatus 114) may be advantageously sized to supply continuous electrical power to sustain at least a 25 mph vehicle speed (e.g., on standard roads or terrain) and to perform missions having at least a 140-mile range.

Additionally, it should be understood that the compartment 140 for the modular electrical power generating apparatus 114 was described as being adjacent the back 132 to facilitate exhaust via the back 132. In alternative embodiments in which the electric traction motors 152 of the electric propulsion system 112 reside in the back, the modular apparatus 114 is located elsewhere such as in a compartment at or nearer the front 130 of the vehicle 100 (e.g., with exhaust still channeled out the back 132).

Furthermore, some improvements disclosed herein relate to modular electrical power generating equipment generally. Along these lines, the modular electrical power generating apparatus 114 may be used as a portable generator (e.g., provisioned with outlets, plugs, terminals, combinations thereof, etc.) to supply electrical power to one or more devices (e.g., vehicular equipment and/or non-vehicular equipment). Moreover, multiple modular electrical power generating apparatus 114 may be used together (e.g., in tandem) for larger applications, and so on.

One embodiment is directed to a method of controlling an electric robotic vehicle. The method includes:
A. piloting the electric robotic vehicle within an environment without any modular electrical power generating apparatus, the electric robotic vehicle having an electric propulsion system constructed and arranged to maneuver the electric robotic vehicle within the environment, and a robotic vehicle body coupled with the electric propulsion system;
B. installing a modular electrical power generating apparatus within a compartment defined by the robotic vehicle body, the modular electrical power generating apparatus including:
   i. a set of electrical power generating devices constructed and arranged to generate electrical power,
   ii. a combustion engine constructed and arranged to drive the set of electrical power generating devices, and
   iii. a modular frame constructed and arranged to support the set of electrical power generating devices and the combustion engine within a modular form factor that enables the modular electrical power generating apparatus to install and operate within the compartment defined by the robotic vehicle body to provide electrical power for electric robotic vehicle propulsion, and
C. maneuvering the electric robotic vehicle within the environment while the modular electrical power generating apparatus is installed and operates within the compartment.

In some arrangements, the method further includes, after the modular electrical power generating apparatus is installed within the compartment defined by the robotic vehicle body, replacing the modular electrical power generating apparatus with another modular electrical power generating apparatus to enable the electric robotic vehicle to maneuver within the environment while the other modular electrical power generating apparatus is installed and operates within the compartment.

Another embodiment is directed to a modular electrical power generating apparatus which includes:
A. a set of electrical power generating devices constructed and arranged to generate electrical power;
B. a combustion engine constructed and arranged to drive the set of electrical power generating devices; and
C. a modular frame constructed and arranged to support the set of electrical power generating devices and the combustion engine within a modular form factor that enables the modular electrical power generating apparatus to install and operate within a compartment of an electric robotic vehicle to provide electrical power for electric robotic vehicle propulsion.

Yet another embodiment is directed to an electric robotic vehicle which includes:
A. an electric propulsion system constructed and arranged to maneuver the electric robotic vehicle within an environment;
B. a robotic vehicle body coupled with the electric propulsion system, the robotic vehicle body defining a compartment; and
C. a modular electrical power generating apparatus which includes:
   a set of electrical power generating devices constructed and arranged to generate electrical power,
   a combustion engine constructed and arranged to drive the set of electrical power generating devices, and
   a modular frame constructed and arranged to support the set of electrical power generating devices and the combustion engine within a modular form factor that enables the modular electrical power generating apparatus to install and operate within the compartment defined by the robotic vehicle body to provide electrical power for electric robotic vehicle propulsion.

In some arrangements, the electric propulsion system includes a set of ground engaging members, a set of electric traction motors coupled with the set of ground engaging members, a set of batteries constructed and arranged to store electrical power, and propulsion control circuitry. The propulsion control circuitry is coupled with the set of electric traction motors and the set of batteries to control delivery of electrical power from the set of batteries to the set of electric traction motors to enable the electric robotic vehicle to maneuver within the environment.

In some arrangements, the electric robotic vehicle further includes a fuel tank supported by the robotic vehicle body. Additionally, the modular electrical power generating apparatus further includes a fuel management assembly coupled with the combustion engine, the fuel management assembly being constructed and arranged to manage fuel from the fuel tank for use by the combustion engine.

In some arrangements, the fuel management assembly includes a fuel pump and a fuel additive doser disposed along a fuel delivery path from the fuel tank to the combustion engine. Additionally, the fuel pump is constructed and arranged to supply a heavy fuel from the fuel tank under pressure. Furthermore, the fuel additive dose is constructed and arranged to lubricate the heavy fuel en route to the combustion engine.

In some arrangements, the fuel management assembly further includes a fuel filter disposed along a fuel return path from the combustion engine to the fuel tank. The fuel filter is constructed and arranged to remove particulates from the heavy fuel en route to the fuel tank.

In some arrangements, the robotic vehicle body further defines a front, a back, and a tank space within which the fuel tank resides. Additionally, the cavity within which the modular electrical power generating apparatus installs and operates is disposed adjacent the rear. Furthermore, the tank space is disposed between the front and the cavity.

In some arrangements, the modular electrical power generating apparatus further includes an air handling system coupled with the frame. The air handling system is constructed and arranged to handle air flow for the modular electrical power generating apparatus.

In some arrangements, the air handling system includes a cooling stack disposed along a back side of the robotic vehicle body between the left side and the right side. The cooling stack is constructed and arranged to intake air from a location above the robotic vehicle body and exhaust air to a location adjacent the back side of the robotic vehicle body.

In some arrangements, the cooling stack includes an intercooler coupled with the combustion engine. Additionally, the air handling system further includes a turbocharger coupled with the intercooler and the combustion engine. The turbocharger is constructed and arranged to provide compressed air to the intercooler for intake by the combustion engine in response to engine exhaust.

In some arrangements, the cooling stack further includes an engine radiator coupled with the combustion engine to provide cooling to the combustion engine, and a generator radiator coupled with the set of electrical power generating devices to provide cooling to the set of electrical power generating devices. Additionally, the air handling system further includes a set of fans to provide airflow through the engine radiator and the generator radiator.

In some arrangements, the propulsion control circuitry includes a power stage coupled the set of electric traction motors, and control logic coupled with the power stage. The control logic is constructed and arranged to control operation of the power stage. Additionally, the set of electrical power generating devices includes:
(i) a high-voltage generator coupled with the combustion engine, the high-voltage generator being constructed and arranged to supply electrical power to the set of electric traction motors through the power stage; and
(ii) a low-voltage generator coupled with the combustion engine, the low-voltage generator being constructed and arranged to supply electrical power to the control logic, the low-voltage generator being constructed and arranged to continuously produce a lower voltage than the high-voltage generator.

In some arrangements, the set of batteries includes a high-voltage traction battery pack constructed and arranged to supply power the set of electric traction motors through the power stage, and a low-power battery constructed and arranged to supply power to the control logic. Additionally, the high-voltage generator is further constructed and arranged to charge the high-voltage traction battery pack, and the low-voltage generator is further constructed and arranged to charge the low-power battery.

In some arrangements, the high-voltage generator includes a high-voltage, three-phase alternating current (AC) alternator constructed and arranged to produce three-phase AC power.

In some arrangements, the high-voltage, three-phase AC alternator is constructed and arranged to provide at least 75 kW continuously to power the set of electric traction motors and charge the traction pack simultaneously.

In some arrangements, the set of ground engaging members includes a left track disposed along a left side of the robotic vehicle body and a right track disposed along a right side of the robotic vehicle body. Additionally, the set of electric traction motors includes a left electric traction motor coupled with the left track to move the left track and a right electric traction motor coupled with the right track to move the right track. Furthermore, the electric robotic vehicle further includes a wireless interface coupled with the propulsion control circuitry to enable the electric propulsion system to be wirelessly controlled from a remote location.

In some arrangements, the modular electrical power generating apparatus further includes a modular apparatus control unit coupled with the combustion engine. The modular apparatus control unit is constructed and arranged to run the combustion engine in response to a run command from the remote location and disable the combustion engine in response to a disable command from the remote location.

In some arrangements, the modular electrical power generating apparatus further includes a set of pneumatic vibration absorbing devices coupled with the frame and the combustion engine. The set of pneumatic vibration absorbing devices is constructed and arranged to enable the modular electrical power generating apparatus to continue providing electrical power for electric robotic vehicle propulsion and while withstanding shocks while the electric robotic vehicle maneuvers through the environment.

Some embodiments relate generally to electric vehicles, and more specifically to a liquid-fuel powered, modular range extender that can be applied to a new or existing electric vehicle.

It should be appreciated that ground robotic vehicles, also known as “ground robots,” are tracked, remote-controlled vehicles that find common applications in scenarios that are not safe or optimal for human operators.

Previous ground robotic vehicles have included vehicles powered by diesel fuel, gasoline, or electricity. Electric ground robots have become increasingly popular due to their relatively quiet operation, lack of emissions, ability to function in low-oxygen environments, and high torque at low speeds.

Although electric ground robots provide many advantages over robots powered by diesel fuel and gasoline, they can suffer from limited range. Some manufacturers have attempted to address this limitation by adopting a parallel-hybrid design that enables both an electric motor and a fuel-powered engine to rotate a ground robot’s drive shaft. Such parallel-hybrid systems can extend the robot’s range based on the amount of liquid fuel stored in an onboard fuel tank. However, these systems also require the engine to be running continuously or at least intermittently while the electric motors are also running. This requirement can make these systems less attractive in scenarios requiring quiet operation or low emissions. In addition, parallel-hybrid designs fully integrate a liquid-fuel engine and electric motors in a single drive train, making them unsuitable as upgrades to existing electric robots. What is needed, therefore, is a way to extend the range of an electric robot as an upgrade or modular addition without requiring simultaneous operation of an engine.

The above need is addressed at least in part by providing a modular, liquid-fuel powered range extender that can be added to a new or existing electric ground robot as disclosed herein and in accordance with certain embodiments. The modular range extender includes an engine and an electric generator configured to charge a battery of the electric ground robot. In some examples, the modular range extender further includes an integrated fuel tank and/or quick disconnects for connecting to an integrated or external fuel tank, which may be selected from among multiple fuel tanks of different sizes.

Advantageously, the modular range extender can turn on the engine when needed for charging the battery and can turn off the engine when not needed or when circumstances call for quiet operation or low emissions. The modular range extender thus overcomes the drawbacks of parallel-hybrid designs, as it can be applied as a module or upgrade to an existing electric ground robot and avoids the requirement for simultaneous engine and motor operation.

Certain embodiments are directed to a modular range extender for an electric vehicle. Other embodiments are directed to an electric vehicle that includes a modular range extender. Further embodiments are directed to a method of extending the range of an electric vehicle. Still further embodiments are directed to a method of upgrading an electric vehicle for extending its range.

Although certain embodiments are described in the context of a ground robotic vehicle, embodiments are not limited to this context but may extend to other electric vehicles, such as electric automobiles, trucks, boats, aircraft, and the like.

According to one or more embodiments, the ground robotic tactical vehicle range extender (TREX) is a modular heavy fuel combustion engine based electrical generator system used to provide electricity for the needs of the vehicle. This added source of electricity allows for a significant extension of the vehicles mobile range and charging options. The added modular nature of the TREX allows for ease of maintenance and expands on its opportunities for future system integration, whether it be vehicle based or just used as a standalone generator.

According to one or more embodiments, the TREX operates using heavy fuel, air, and compression to cause combustion within an engine. The fuel is pumped from a source using the TREX low-pressure and high-pressure fuel pumps. This fuel is mechanically filtered of particulate and water separated, as well as lubricated using a lubricity additive doser. The ambient air is filtered, pressurized, and cooled using a force induction turbocharger and intercooler system. This repeated combustion cycle results in mechanical rotational energy of a drive shaft that is then converted to high-voltage (HV) 3-phase alternating current (3Φ-AC) power, using a HV electric motor/generator, and low voltage (LV) 3Φ-AC power, using a LV electric generator (alternator). Each power source is passed through its own respective rectifier to produce direct-current power for system electrical consumption, management, and/or storage. The engine is controlled using a dedicated engine control unit (ECU) with programmed firmware to optimize engine performance. Exhaust gases are expelled thru the turbocharger and mufflered exhaust system. The engine and generator both have dedicated cooling systems featuring cooling pumps and radiators for maintaining temperatures. In some examples, the intercooler and radiators for the different cooling systems are housed together in a single radiator assembly, where they are cooled together using the same cooling fans and airflow. Power is software controlled using power distribution units (PDUs). These components are packaged into a modular unit, allowing for easy maintenance and adaptable functionality. In some examples, the modular unit includes componentry to isolate internal parts from shock and vibration. Such componentry may be applied to individual parts and subassemblies, and/or to the module as a whole.

### EXAMPLE NOVEL FEATURES

The TREX design provides a solution for providing on-the-move, uncrewed vehicle hybrid power. Example features include:
Maximizes efficiency and range without overcharging batteries.
No max generator power changes vs engine speed in our operating range.
Ability to optimize best efficiency per operation required max power
Eliminates need to check for exceeding max generator speed vs voltage.
Gradual regen torque reduction versus abrupt change due to discontinuity above critical vehicle speed.
Scalable and tailorable | sealed compartment integration.
Liquid cooled

Modularity of the TREX is achieved at least in part by way of the following:
1. Packaging for Modularity
   a. Structural Mounting & Isolation
      i. The modular mounting of the components that compose the TREX allow for an individual and statically structural assembly. The engine, generator, radiator, and vibration and shock isolation components are also contained in this modular TREX assembly, allowing for ease of operation, maintenance, sparing, testing, and storing of the TREX.
   b. Cooling
      i. A self-contained modular cooling system is separated into three loops: Engine, Generator, and Intercooler. The modularity of the cooling systems is due to the fact that all the components needed for operation are located within the TREX and can remain filled with fluid during repair or replacement (ROR) activities requiring removal of the TREX from the vehicle. The Engine and Generator loops use liquid-to-air cooling, while the intercooler uses air-to-air cooling. The three loops are combined into a single radiator that is mounted to the cradle and side walls of the TREX.
   c. Fuel
      i. The modular heavy fuel system is separated into two loops: supply and return. The supply loop begins with a low-pressure portion that allows for a universal interconnection to a fuel source using a quick disconnect fitting with a hose connected to a low-pressure pump with heaters, filtration, water separation, and air separation. The supply loop then proceeds thru a heavy fuel lubricity doser, to allow the use of various heavy fuels, such as: JET-A, Diesel #2, JP-8, JET-A1, JP-5, etc. The Supply loop then proceeds into a high-pressure portion with a high-pressure fuel pump, common fuel rail, and fuel injectors. The return loop allows excess fuel to be returned to the original fuel source. This is done using a manifold and an additional filtration method to ensure clean fuel and monitoring of fuel system performance. An additional universal interconnection to the fuel source using a quick disconnect fitting of opposite gender from the supply continues to allow for modularity of the TREX assembly.
   d. Electric Generation
      i. Modular electrical generation is achieved using a series-hybrid electric system separated into two subsystems: combustion engine and electric generator. The heavy-fuel combustion engine turns energy-dense fuel into rotational energy. This rotational energy is transferred thru a vibration dampening coupler and into a 3-phase electrical generator. The electrical generator converts the rotational energy into high voltage, 3-phase AC electrical power. The AC power is then converted to DC power using an electrical rectifier. The DC power is connectorized at the rectifier, allowing for modularity of the TREX assembly.
   e. Power Distribution
      i. Modular power distribution is separated into low-voltage and ground circuits. Power is software-controlled using modular power distribution units (PDUs) that interface to a connectorized panel for modularity of the TREX assembly. The PDUs distribute and regulate the power using various electrical harnesses and bus bars. The grounding circuit is implemented using dedicated bus bars and a dedicated external interconnect allowing for easy integration of the TREX grounds with the host system's grounding path. The modular system also provides grounding straps to offer low resistance discharge paths for critical devices.
   f. Air Induction System
      i. A modular air induction system is separated into two loops: intake and exhaust. The intake loop is self-contained in the TREX and begins with a filtered air intake. The intake air is then pressured/boosted through the turbocharger and cooled with the intercooler. The engine then proceeds to use this boosted air with fuel for the combustion process. Once combustion has taken place, the exhaust loop begins by forcing the exhaust air through the exhaust manifold and into the turbocharger. The exhaust loop then continues with an isolated exhaust pipe and universal exhaust clamping interface, to allow for easy attachment of an ancillary muffler.
   g. Sensors
      i. Various self-contained sensors (temperature, pressure, humidity, voltage, etc.) are installed in and around the TREX and provide inputs to logic for controlling and/or logging data for the cooling system, fuel system, air induction system, combustion engine, and electrical generator. These sensors interface with the modular PDUs and ECU contained within the TREX assembly.

### ADDITIONAL FEATURES

An ECU (engine control unit) controls Engine Speed & a GCU (generator control unit) controls generator current. A VCC (vehicle control computer) will provide outer-loop control for those two controllers: one implementation used power control due to power limits. whereas another implementation prefers current control due to operating closer to charging limits. The selected simple generator current control method is based on battery current and max charge rate reported from a BMS (battery management system).

The design provides capacity for silent drive missions at any time (by maximizing battery capacity available throughout the mission). The design further provides variable power output to prevent overcharging of batteries at higher SOCs (states of charge). The system can optimize best efficiency per operation required max power. For example, the system can vary engine speed with power level for torque matching and best efficiency and operate over a wide voltage range (600 to 800v). Precautions are taken to avoid overspinning the generator at lower voltages while keeping the engine running through the majority of a mission, which may be preferred due to inability for diesel to quickly warm up after shut down.

A simple generator current control method may be implemented as follows:
1) Output Command = Previous Command + Δ (Charge Rate + Target Charge Rate).
2) To prevent instability & overcharge, use a slow response filter to normally change commanded current & no filter when an overcharge is detected.
3) Respond to overcharging events as indicated in table below
4) Derate power if any equipment over temperature threshold.
5) Disable generator if overvoltage or output is too low.
6) Set Engine to best Engine speed for the selected Gen. Power.

Having described certain embodiments, numerous alternative embodiments or variations can be made. Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

While various embodiments of the present disclosure have been particularly shown and described, it will be understood by those skilled in the art that various changes in form and details may be made therein without departing from the spirit and scope of the present disclosure as defined by the appended claims. Such modifications and enhancements are intended to belong to various embodiments of the disclosure.

What is claimed is:

1. An electric robotic vehicle, comprising:
an electric propulsion system constructed and arranged to maneuver the electric robotic vehicle within an environment;
a robotic vehicle body coupled with the electric propulsion system, the robotic vehicle body defining a compartment; and
a modular electrical power generating apparatus which includes:
a set of electrical power generating devices constructed and arranged to generate electrical power,
a combustion engine constructed and arranged to drive the set of electrical power generating devices, and
a modular frame constructed and arranged to support the set of electrical power generating devices and the combustion engine within a modular form factor that enables the modular electrical power generating apparatus to install and operate within the compartment defined by the robotic vehicle body to provide electrical power for electric robotic vehicle propulsion.

2. The electric robotic vehicle of claim 1, wherein the electric propulsion system includes:
a set of ground engaging members;
a set of electric traction motors coupled with the set of ground engaging members;
a set of batteries constructed and arranged to store electrical power; and
propulsion control circuitry coupled with the set of electric traction motors and the set of batteries to control delivery of electrical power from the set of batteries to the set of electric traction motors to enable the electric robotic vehicle to maneuver within the environment.

3. The electric robotic vehicle of claim 2, further comprising:
a fuel tank supported by the robotic vehicle body; and
wherein the modular electrical power generating apparatus further includes:
a fuel management assembly coupled with the combustion engine, the fuel management assembly being constructed and arranged to manage fuel from the fuel tank for use by the combustion engine.

4. The electric robotic vehicle of claim 3, wherein the fuel management assembly includes a fuel pump and a fuel additive doser disposed along a fuel delivery path from the fuel tank to the combustion engine;
wherein the fuel pump is constructed and arranged to supply a heavy fuel from the fuel tank under pressure; and
wherein the fuel additive dose is constructed and arranged to lubricate the heavy fuel en route to the combustion engine.

5. The electric robotic vehicle of claim 4, wherein the fuel management assembly further includes:
a fuel filter disposed along a fuel return path from the combustion engine to the fuel tank, the fuel filter being constructed and arranged to remove particulates from the heavy fuel en route to the fuel tank.

6. The electric robotic vehicle of claim 5, wherein the robotic vehicle body further defines a front, a back, and a tank space within which the fuel tank resides;
wherein the cavity within which the modular electrical power generating apparatus installs and operates is disposed adjacent the rear; and
wherein the tank space is disposed between the front and the cavity.

7. The electric robotic vehicle of claim 2, wherein the modular electrical power generating apparatus further includes:
an air handling system coupled with the frame, the air handling system being constructed and arranged to handle air flow for the modular electrical power generating apparatus.

8. The electric robotic vehicle of claim 7, wherein the air handling system includes:
a cooling stack disposed along a back side of the robotic vehicle body between the left side and the right side, the cooling stack being constructed and arranged to intake air from a location above the robotic vehicle body and exhaust air to a location adjacent the back side of the robotic vehicle body.

9. The electric robotic vehicle of claim 8, wherein the cooling stack includes an intercooler coupled with the combustion engine; and
wherein the air handling system further includes a turbocharger coupled with the intercooler and the combustion engine, the turbocharger being constructed and arranged to provide compressed air to the intercooler for intake by the combustion engine in response to engine exhaust.

10. The electric robotic vehicle of claim 9, wherein the cooling stack further includes:
an engine radiator coupled with the combustion engine to provide cooling to the combustion engine; and
a generator radiator coupled with the set of electrical power generating devices to provide cooling to the set of electrical power generating devices; and
wherein the air handling system further includes a set of fans to provide airflow through the engine radiator and the generator radiator.

11. The electric robotic vehicle of claim 2, wherein the propulsion control circuitry includes:
a power stage coupled the set of electric traction motors, and
control logic coupled with the power stage, the control logic being constructed and arranged to control operation of the power stage; and
wherein the set of electrical power generating devices includes:
a high-voltage generator coupled with the combustion engine, the high-voltage generator being constructed and arranged to supply electrical power to the set of electric traction motors through the power stage; and
a low-voltage generator coupled with the combustion engine, the low-voltage generator being constructed and arranged to supply electrical power to the control logic, the low-voltage generator being constructed and arranged to continuously produce a lower voltage than the high-voltage generator.

12. The electric robotic vehicle of claim 11, wherein the set of batteries includes:
a high-voltage traction battery pack constructed and arranged to supply power the set of electric traction motors through the power stage; and
a low-power battery constructed and arranged to supply power to the control logic; and
wherein the high-voltage generator is further constructed and arranged to charge the high-voltage traction battery pack; and
wherein the low-voltage generator is further constructed and arranged to charge the low-power battery.

13. The electric robotic vehicle of claim 12, wherein the high-voltage generator includes a high-voltage, three-phase alternating current (AC) alternator constructed and arranged to produce three-phase AC power.

14. The electric robotic vehicle of claim 13, wherein the high-voltage, three-phase AC alternator is constructed and arranged to provide at least 75 kW continuously to power the set of electric traction motors and charge the traction pack simultaneously.

15. The electric robotic vehicle of claim 2, wherein the set of ground engaging members includes a left track disposed along a left side of the robotic vehicle body and a right track disposed along a right side of the robotic vehicle body;
wherein the set of electric traction motors includes a left electric traction motor coupled with the left track to move the left track and a right electric traction motor coupled with the right track to move the right track; and
wherein the electric robotic vehicle further comprises:
a wireless interface coupled with the propulsion control circuitry to enable the electric propulsion system to be wirelessly controlled from a remote location.

16. The electric robotic vehicle of claim 15, wherein the modular electrical power generating apparatus further includes:
a modular apparatus control unit coupled with the combustion engine, the modular apparatus control unit being constructed and arranged to run the combustion engine in response to a run command from the remote location and disable the combustion engine in response to a disable command from the remote location.

17. The electric robotic vehicle of claim 15, wherein the modular electrical power generating apparatus further includes:
a set of pneumatic vibration absorbing devices coupled with the frame and the combustion engine, the set of pneumatic vibration absorbing devices being constructed and arranged to enable the modular electrical power generating apparatus to continue providing electrical power for electric robotic vehicle propulsion and while withstanding shocks while the electric robotic vehicle maneuvers through the environment.

18. Modular electrical power generating apparatus, comprising:
a set of electrical power generating devices constructed and arranged to generate electrical power;
a combustion engine constructed and arranged to drive the set of electrical power generating devices; and
a modular frame constructed and arranged to support the set of electrical power generating devices and the combustion engine within a modular form factor that enables the modular electrical power generating apparatus to install and operate within a compartment of an electric robotic vehicle to provide electrical power for electric robotic vehicle propulsion.

19. A method of controlling an electric robotic vehicle, the method comprising:
piloting the electric robotic vehicle within an environment without any modular electrical power generating apparatus, the electric robotic vehicle having an electric propulsion system constructed and arranged to maneuver the electric robotic vehicle within the environment, and a robotic vehicle body coupled with the electric propulsion system;
installing a modular electrical power generating apparatus within a compartment defined by the robotic vehicle body, the modular electrical power generating apparatus including:
a set of electrical power generating devices constructed and arranged to generate electrical power,
a combustion engine constructed and arranged to drive the set of electrical power generating devices, and
a modular frame constructed and arranged to support the set of electrical power generating devices and the combustion engine within a modular form factor that enables the modular electrical power generating apparatus to install and operate within the compartment defined by the robotic vehicle body to provide electrical power for electric robotic vehicle propulsion, and
maneuvering the electric robotic vehicle within the environment while the modular electrical power generating apparatus is installed and operates within the compartment.

20. The method of claim 19, further comprising:
after the modular electrical power generating apparatus is installed within the compartment defined by the robotic vehicle body, replacing the modular electrical power generating apparatus with another modular electrical power generating apparatus to enable the electric robotic vehicle to maneuver within the environment while the other modular electrical power generating apparatus is installed and operates within the compartment.
